(19) United States
(12) Patent Application Publication
(10) Pub. No.: US 2011/0037341 A1
(43) Pub. Date: Feb. 17, 2011

(54) COMMUTATOR, POWER TOOL HAVING AN ELECTRIC MOTOR COMPRISING SUCH A COMMUTATOR, AND METHOD FOR THE PRODUCTION OF A COMMUTATOR

(76) Inventors: Michael Schmohl, Ammerbuch (DE); Helmut Stolpmann, Fridingen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/735,919

(22) PCT Filed: Feb. 11, 2009
(86) PCT No.: PCT/EP2009/000946

§ 371 Date: Oct. 22, 2010

(30) Foreign Application Priority Data
Feb. 25, 2008 (DE) 10 2008 011 504.5

(51) Int. Cl. H01R 39/04; H01R 43/06

(52) U.S. Cl. 310/236; 29/597

(57) ABSTRACT

The invention relates to a commutator (1) comprising electrically conductive commutator segments (12), which are disposed about a rotational axis (10) in a manner free of a pressing material body, and which are electrically insulated from each other by means of an air gap (14) disposed between two adjacent commutator segments (12), characterized in that a fixing means (42) applied to the commutator (1) in a flowable phase in a form-free manner is cured after a flow process between two commutator segments (12) adjoining in the circumferential direction about the rotational axis (10), and that the position of the commutator segments (12) is fixed by the cured fixing means (42), and to a power tool having an electric motor comprising such a commutator, and to a method for the production of a commutator.

The invention relates to a commutator according to the preamble of claim 1, a power tool having an electric motor comprising such a commutator, and a method for the production of a commutator.

Such commutators are used, for example, for electric motors of power tools, where they are routinely subjected to high stresses. In the commutators known from the prior art, the commutator segments, which are arranged about an axis of rotation, are usually connected together by an electrically insulating compression-molded body, which is molded to the commutator segments under pressure. This procedure may produce in the commutator an arch pressure, which is disadvantageous in some applications.

DD 138 455 A1 shows a commutator for electric machines. In this case, the commutator lining is protected against destruction and an inadmissible shape change as a consequence of its intrinsic centrifugal force generated by rings that envelop the commutator on its outside diameter or are embedded in its face sides.

DE 38 13 711 C2 shows a method and a device for final machining of collector blanks that have a plurality of collector strips which are distributed over the periphery at a distance from each other and are electrically insulated from each other by means of grooves.

DE 1 275 193 A shows a method for producing a commutator for electric machines. In this case, the commutator laminae are centered by means of insulating retaining rings that are fitted into the face-side annular groove of the commutator and that project beyond the face sides of the laminae in themselves and in relation to a commutator hub that is sheathed with an insulating material.

DE 37 14 098 A1 discloses a commutator, in which the body that is formed by the commutator segments does not exhibit any arch pressure, at least in the dynamically and thermally unstressed state. In addition, the invention proposes, among other things, dispensing with a compression-molded body and anchoring the commutator segments on a hub body only by means of a reinforcing ring and providing an air gap insulation between the commutator segments.

The object of the invention is to provide a commutator, a power tool with an electric motor comprising a commutator, and a method for the production of a commutator, all of which are improved even more over the known commutators, power tools, and production methods. One embodiment provides a commutator that exhibits a high current carrying capacity and a high mechanical strength, so that, for example, higher torques and/or higher rotational speeds for the associated electric motor and, thus, the power tool are possible. In addition, the production method is to be simplified with respect to the highly stressable commutators that are known from the prior art.

This engineering object is achieved by means of the commutator defined in claim 1 as well as by means of the power tool defined in the independent claim and the production method defined in the additional independent claim. Particular embodiments of the invention are defined in the dependent claims.

In one embodiment, the commutator exhibits electrically conductive commutator segments, which are disposed about an axis of rotation without a compression-molded body and which are electrically insulated from each other by means of an air gap disposed between adjacent commutator segments. A fixing agent, which is applied to the commutator in a free-flowing phase without a mold, is cured after a flow process has taken place between two commutator segments adjoining in the circumferential direction about the axis of rotation; and the position of the commutator segments is fixed by the cured fixing agent.

In the still uncured state, the fixing agent that is applied without a mold flows into the air gap, which extends axially parallel to the axis of rotation, between two adjacent commutator segments at least in some sections and after curing fixes the commutator segments in their position in relation to each other and to a drive shaft of the electric motor. One embodiment provides, apart from the fixing agent, which consists of an electrically insulating material, such as, for example, a thermally curable synthetic resin, only an air insulation between the commutator segments.

The segments can be disposed radially inwards in contact with a sleeve-shaped hub body or directly with the drive shaft of the electric motor. To this end the hub body or the drive shaft has an electrically insulating surface or is made totally of an electrically insulating material at least in this section. Insofar as the commutator has a hub body, it can be mounted in a rotationally rigid manner on the drive shaft of the electric motor. The surfaces of the drive shaft and/or the hub body that face each other can have depressions and/or elevations, in particular, axially extending grooves or webs, by means of which cavities are formed, in which the fixing agent can also penetrate, and as a result of which the rotationally rigid connection between the hub body and the drive shaft is secured.

The fixing agent is not applied until the production process of the commutator has already been completed, preferably after the electrical connecting leads for the windings of the motor or the generator have also been already connected to the commutator segments.

In one embodiment, the fixing agent is in fixing contact only with a section of the commutator segments that lies radially inwards in relation to the axis of rotation. In this case, the radially inwards lying section can be delimited from an adjoining section by means of a suitable geometric design, for example, an hourglass-shaped tapering. The fixing agent that makes contact only in the radially inwards direction guarantees that the air gap between the commutator segments continues to extend adequately far in the radial direction to ensure an effective air flow cooling of the commutator in operation. In addition, it is guaranteed, unlike in the design of molding on the compression-molded body, that the air gap is sufficiently deep. As a result, it is possible to eliminate deposits or, in any event, the negative effects of such deposits that can be produced owing to the abrasive wear in the area of the head sections, which are a part of the commutator segments and which form the commutator running surfaces, and can result in a deterioration of the operational reliability of the commutator.

In one embodiment, the fixing agent is in fixing contact over at least 20%, preferably at least 50%, and in particular at least 80% of the radial extension of a section of the commutator segments that lies radially inwards in relation to the axis of rotation. In this case, the section that lies radially inwards has an extension in the radial direction that is less than 50%, preferably less than 30%, of the total radial extension of the commutator segments. Thus, in one embodiment more than 50%, preferably more than 80%, of the radial extension of the commutator segments remain uncovered by the fixing agent and are available for the formation of the air gap.

In one embodiment, the commutator segments have a connecting section for the connection of a winding lead of an associated electric motor, in particular an armature winding. The connecting section can be formed by bending down an axial end section of the commutator segment so as to form a hook.

In one embodiment, the extension of the commutator segments is reduced in the circumferential direction at its connecting section and/or at a section, bordering the connecting section, in relation to the radial extension of the commutator segments in its section forming the running surface. This tapering off of the commutator segments improves the inflow of the fixing agent that is applied without a mold. In addition, the expansion of the air gap improves the air cooling of the commutator. The tapering can be configured in a stepped manner in the axial direction or continuously, in particular, by means of a sloped edge, by means of which a funnel shape for the inflow of the fixing agent, which is applied without a mold, is formed in the axial direction, relative to the axis of rotation.

In one embodiment, the fixing agent is in fixing contact in the area of the axial end of the commutator segment that faces the connecting section. In particular, the fixing agent can be applied in the area of the axial end of the commutator segment that faces the connecting section and can extend from there into the air gap at least in some sections. In this case, the fixing agent does not have to be in fixing contact with the commutator segments over the entire axial extension. In one embodiment, the fixing agent is in fixing contact over at least 25%, preferably at least 50%, and, in particular, at least 75% of the axial extension of the commutator segments.

In one embodiment, the distance between two commutator segments in the circumferential direction about the axis of rotation, in particular, the distance between two radially inwards lying sections of adjacent commutator segments, is matched to the viscosity of the fixing agent, applied in the free-flowing phase, such that owing to the resulting capillarity, i.e., the resulting capillary forces, the fixing agent flows into the area between two commutator segments. In addition, the flow process can be assisted by the gravitational forces acting on the fixing agent.

In one embodiment, the winding leads, which are a part of an electric motor and which are connected to the commutator segments, are also anchored in relation to the commutator with the fixing agent. To this end the fixing agent can be applied preferably on the connecting section of the commutator segments with the attached winding leans and from there conveyed into the air gap between the commutator segments by means of the capillary forces and/or the gravitational force.

In one embodiment, the fixing agent is a resin that can be trickled onto the commutator. The bubble formation, which occurs in a trickle resin, in particular a styrene-containing trickle resin, during the curing process and which is absolutely undesired, is minimized by the flow process that is expedited by the capillarity.

In one embodiment, the commutator segments are anchored on the hub body or directly on the drive shaft by means of a clamping element, preferably by means of at least two clamping elements, disposed at axially different positions. For example, the clamping element that is used can be, in particular, a clamping ring, which can be made of a fiber-reinforced, in particular glass-fiber-reinforced, synthetic plastic; or the clamping ring can be made of a ceramic. The resilient deformation of the clamping element and/or the commutator segments and/or the hub body and/or the drive shaft makes it possible to provide a high clamping force.

The invention also relates to a power tool, which has an electric motor comprising the commutator described above. In this case, it is especially advantageous that the fixing agent can anchor simultaneously both the winding leads, for example, an armature of the electric motor, and the commutator segments.

The invention also relates to a method that is intended for the production of an above-described commutator and wherein a fixing agent is applied on the commutator in the free-flowing phase without a mold and is cured after a flow process between two commutator segments adjoining in the circumferential direction about the axis of rotation; and, in so doing, the position of the commutator segments is fixed.

Other advantages, features, and details of the invention are apparent from the dependent claims and the following description, in which one embodiment is described in detail with reference to the drawings. The features mentioned in the claims and the description may be essential for the invention either individually by themselves or in any combination.

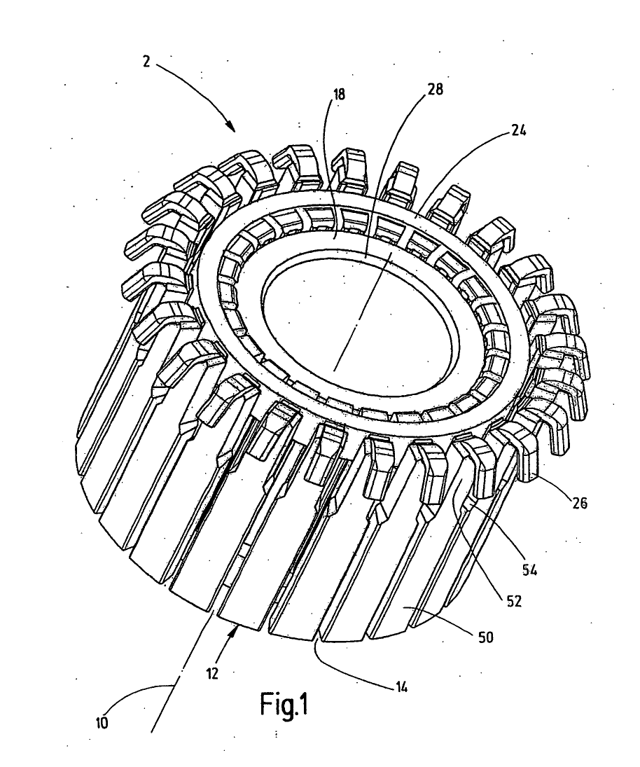

FIG. 1 shows a perspective view of a composite system with electrically conductive commutator segments,

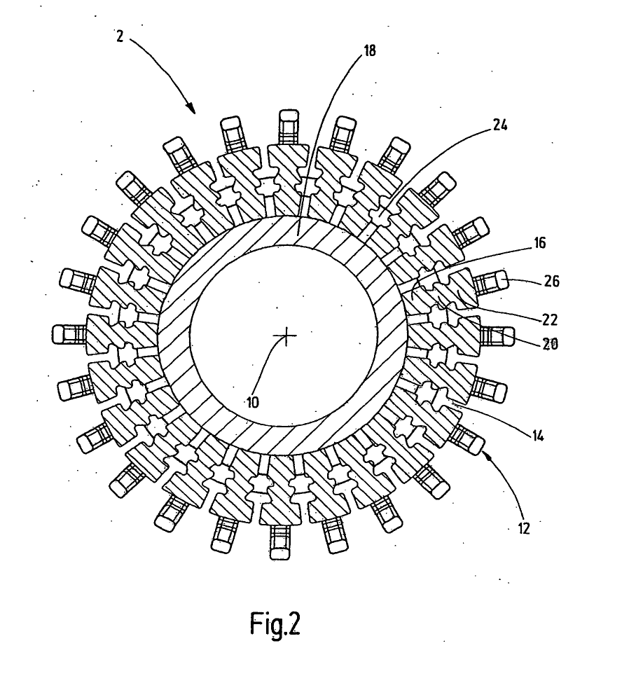

FIG. 2 shows a sectional view of the composite system from FIG. 1,

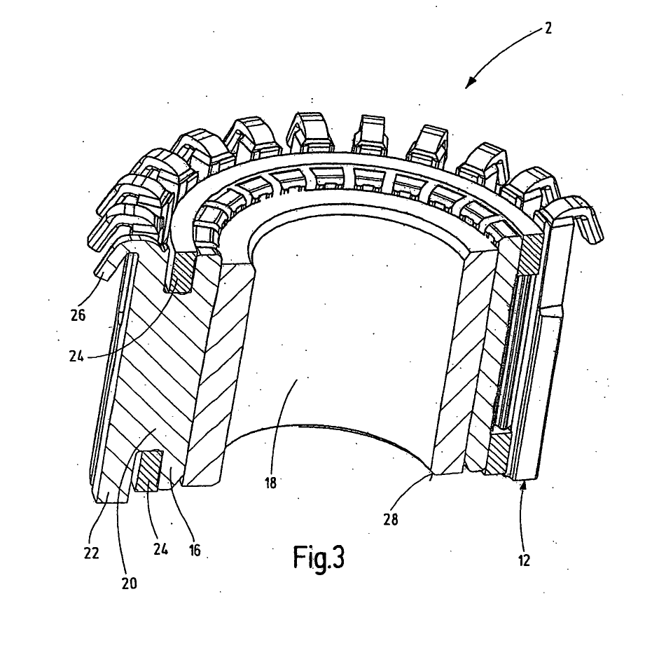

FIG. 3 shows a perspective view of a section of the composite system from FIG. 1,

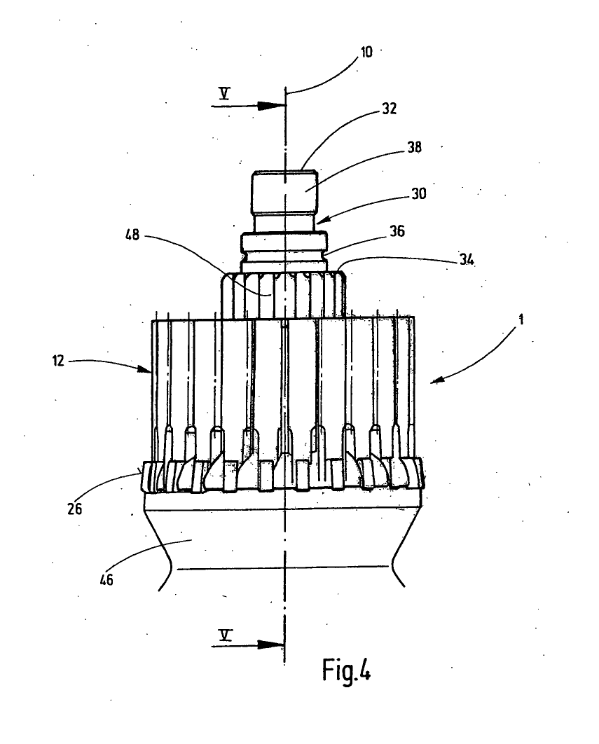

FIG. 4 shows a view of an end section of a drive shaft of an electric motor with a commutator according to the invention, and

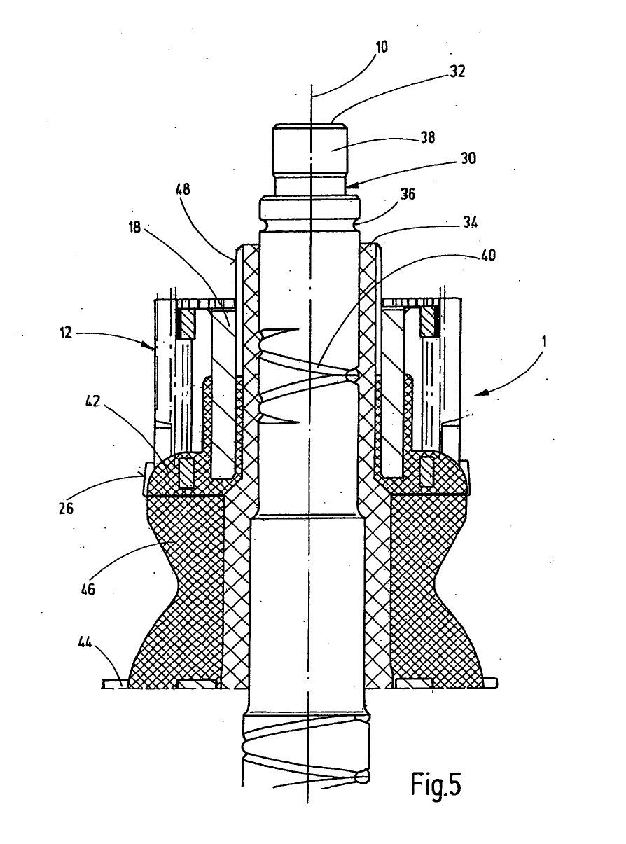

FIG. 5 shows a sectional view along the line V-V of the end section of the drive shaft from FIG. 4.

FIG. 1 shows a perspective view of a composite system 2 with electrically conductive commutator segments 12 that are disposed about an axis of rotation 10. Due to an air gap 14, arranged between each of two adjacent commutator segments 12, these commutator segments are electrically insulated from each other. FIG. 2 shows a sectional view of the composite system 2 from FIG. 1 at right angles to the axis of rotation 10. FIG. 3 is a perspective view of a section of the composite system 2 from FIG. 1 along the axis of rotation 10.

It is especially apparent from FIG. 3 that each of the commutator segments 12 rests with a section 16, which lies radially inwards in relation to the axis of rotation 10, against a sleeve-shaped hub body 18. While the commutator segments 12 are made of an electrically conductive material, for example, copper, the hub body 18 is made of an electrically insulating material, for example, a fiber-reinforced, in particular glass-fiber-reinforced, polymer plastic, for example, a thermosetting plastic. As an alternative, the hub body 18 can also have an electrically insulating coating on its preferably circular-cylindrical outer surface that faces the commutator segments 12.

Besides the radially inwards lying section 16, which can also be referred to as the base section, the commutator segments 12 have a connecting section 20 and also a head section 22, forming the running surface of the commutator 1. Here, the connecting section 20 exhibits a shorter axial extension than the adjacent base section 16 and the adjacent head section 22, so that a recess is formed on the opposite axial ends of the commutator segments 12 in the area of the connecting section 20. In the composite system 2, this recess forms a groove that encircles concentrically to the axis of rotation 10 and in which a respective reinforcing ring 24 is put as the clamping element 24. In this respect, the axial extension of the clamping element 24 is greater than the axial projecting length of the base section 16 in relation to the connecting section 20, so that the clamping element 24 projects axially beyond the end of the base section 16. The head section 22 also has a longer axial extension than the connecting section 20 and projects even beyond the clamping element 24 on the axial end sides.

On an axial end, the head section 22 forms, as one piece, a connecting section 26, which is formed by bending down in a hook-like manner the head section 22 in the embodiment. A connecting line of a winding of the associated electric motor can be mounted on the connecting section 26 and can be electrically connected to the commutator segment 12.

It is especially evident from FIG. 1 that an additional section 52, bordering the connecting section 26, has a smaller extension in the circumferential direction about the axis of rotation 10 than the section 50 that borders this additional section 52 and is a part of the commutator segment 12 and that forms the running surface for the commutator 1. In one embodiment, the smaller extension is provided only in the head section 22 of the commutator segments 12, whereas the base section 16 and/or the connecting section 20 exhibit a constant extension in the circumferential direction over the entire axial length. The transition from the running surface section 50 to the additional section 52 is produced by a sloped face 54. The result is a funnel-shaped expansion of the air gap 14 at the transition from the running surface section 50 to the additional section 52. The planes, which are defined by the areas that laterally border the additional section 52, run parallel to the axis of rotation 10 and can also run parallel to each other; or these planes can be inclined in relation to each other such that these planes intersect in the axis of rotation 10. Correspondingly, in the area between the additional sections 52 of the adjacent commutator segments 12, the width of the air gap 14 can be independent of the radial distance from the axis of rotation 10 in the circumferential direction; or the width of the air gap 14 tapers off as the distance from the axis of rotation 10 decreases. The axial extension of the additional section 52 ranges from 10% to 60%, in particular from 20% to 45%, and preferably from 30% to 35% of the axial extension of the running surface section 50. The bent connecting section 26 has an extension that is even more reduced in the circumferential direction than the additional section 52.

The hub body 18 can be configured in a sleeve-shaped manner with a preferably circular-cylindrical borehole, which is expanded on its axial end sides. In this case, the expansion can be formed by a radius or at least in some sections by a conical surface. In the embodiment, the hub body 18 is expanded axially by a chamfer 28 on the end side.

FIG. 2 shows that the radially inwards lying section 16 is delimited from the connecting section 20 by an hourglass-shaped tapering. The head section 22 is delimited by an hourglass-shaped tapering in relation to the connecting section 20. Between the radially inwards lying sections 16 and the head sections 22 of two adjacent commutator segments 12, the width of the air gap 14 is essentially independent of the radial distance from the axis of rotation, i.e., constant, whereas the air gap 14 in the area of the connecting section 20 has a larger width. The radially inwards lying section 16 that faces the hub body 18 has a flat face surface or a face surface which is arched concentrically in relation to the axis of rotation 10, and with which the commutator segment 12 is in contact with the hub body 18.

In one embodiment, stabilizing elements may be disposed in the air gap 14, in particular in the area of the air gap 14 that is bounded by the connecting sections 20 of the adjacent commutator segments 12. In this case, the clamping elements 24, in particular, reinforcing rings, cannot be in contact with the commutator segments 12 or, in any event, can be not only in contact with the commutator segments 12, but rather in contact with the stabilizing elements. The stabilizing elements can be formed, for example, by cylindrical stabilizing bodies, against which the clamping elements 24 rest in a clamping manner. As a result, the clamping force of the clamping element 24 is introduced into the commutator segments 12 via the stabilizing elements and, in so doing, the stability of the commutator 1 is enhanced even more. Such a stabilizing element can be disposed in each air gap 14 of the commutator 1; or stabilizing elements may be disposed only in some air gaps 14 which are arranged preferably uniformly distributed in the circumferential direction.

FIG. 4 is a view of an end section of a drive shaft 30 of an electric motor with a commutator 1 according to the invention. FIG. 5 is a sectional view along the line V-V of the end section of the drive shaft 30 from FIG. 4.

The drive shaft 30 has a preferably metal shaft core 32, which is surrounded at least in some sections by a shaft shell 34 made of an electrically insulating material. On the end side, the shaft core 32 emerges from the shaft shell 34 and has in this section a circumferential groove 36, for example, for insertion of a rotary shaft seal, and a journal 38. In the area of the shaft shell 34, the shaft core 32 has at least in some sections and, preferably, circumferential depressions, for example, a helical groove, by means of which the rotationally rigid connection is tightened between the shaft shell 34 and the shaft core 32.

On the outside, the shaft shell 34 has webs 48, which run parallel to the axis of rotation 10, with grooves in between the webs. On the webs 48, the hub body 18 is in clamping contact with the shaft shell 34 and, thus, with the drive shaft 30. In this case, the commutator 1 is mounted on the drive shaft 30 in such a manner that the connecting section 26, which is to be connected to the winding leads, lies on the end of the commutator 1 that is at a distance from an end of the drive shaft 32 that is near the commutator 1.

At the same time, the fixing agent 42, which is applied on the commutator 1 in the free-flowing phase without a mold, covers the area of the connecting section 26 and from there has flowed into the area of the air gap 14 between each of two commutator segments 12. Here, the geometry of the air gap 14, in particular, the geometry of the radially inwards lying sections 16 of the commutator segments 12, is matched to the viscosity of the fixing agent 42 in the free-flowing phase in such a manner that in the cured state the fixing agent 42 extends into the air gap 14 between 40% and 60% of the axial extension of the commutator segments 12. In the radial direction the cured fixing agent 42 is in contact with the commutator segments 12 in an area ranging from about 40% to 60% of the radial extension of the radially inwards lying section 16.

In addition, the fixing agent 42 flows into the grooves, arranged between the webs 48, and additionally anchors the hub body 18 on the shaft shell 34 and, thus, on the drive shaft 30. Similarly, the fixing agent 42 in the grooves between the webs 48 does not flow over the entire axial length, but rather only so far as it is also in contact with the commutator segments 12, in the embodiment between 40% and 60% of the axial extension of the commutator segments 12.

The fixing agent 42 adjoins a molded body 46, which is made of an electrically insulating material and which on the drive shaft 30 adjoins the commutator 1 in the direction of an armature winding 44, which is depicted only partly in the FIGS. 4 and 5. In order to apply said fixing agent, the drive shaft 30 can be rotated with the mounted commutator 1 in the horizontal position of the axis of rotation 10; and, in so doing, the fixing agent 42 can be trickled from the top onto the connecting section 26. Owing to the resulting capillary forces and/or owing to the gravitational forces acting on the fixing agent 42, the fixing agent is distributed into the air gap 14 between the commutator segments 12 and/or into the grooves formed by the webs 48.

1. A commutator (1) with electrically conductive commutator segments (12), which are disposed about an axis of rotation (10) without a compression-molded body and which are electrically insulated from each other by means of an air gap (14) disposed between two adjacent commutator segments (12), characterized in that a fixing agent (42), which is applied to the commutator (1) in a free-flowing phase without a mold, is cured after a flow process between two commutator segments (12) adjoining in the circumferential direction about the axis of rotation (10), and that the position of the commutator segments (12) is fixed by the cured fixing agent (42).

2. The commutator (1) according to claim 1, characterized in that the fixing agent is not applied until the production process of the commutator has already been completed, preferably after the electrical connecting leads for the windings of a motor or a generator have also been already connected to the commutator segments.

3. The commutator (1) according to claim 1, characterized in that in the cured state the fixing agent (42) is in fixing contact with a section (16) of the commutator segments (12) that lies radially inwards in relation to the axis of rotation (10).

4. The commutator (1) according to claim 1, characterized in that the fixing agent (42) is in fixing contact over at least 20%, preferably at least 50%, and in particular at least 80% of the radial extension of a section (16) of the commutator segments (12) that lies radially inwards in relation to the axis of rotation (10).

5. The commutator (1) according to claim 1, characterized in that the commutator segments (12) have a connecting section (26) for the connection of a winding lead of an electric motor, and that the fixing agent (42) is in fixing contact in the area of the axial end of the commutator segment (12) that faces the connecting section (26).

6. The commutator (1) according to claim 1, characterized in that the fixing agent (42) is in fixing contact over at least 25%, preferably at least 50%, and in particular at least 75% of the radial extension of the commutator segments (12).

7. The commutator (1) according to claim 1, characterized in that the distance between two commutator segments (12) in the circumferential direction about the axis of rotation (10) is matched to the viscosity of the fixing agent (42), which is applied in the free-flowing phase, in such a manner that, owing to the resulting capillarity, the fixing agent (42) is distributed axially along the axis of rotation (10).

8. The commutator (1) according to claim 1, characterized in that the winding leads, which are a part of an electric motor and which are connected to the commutator segments (12), are also fixed in relation to the commutator (1) with the fixing agent (42).

9. The commutator (1) according to claim 1, characterized in that the fixing agent (42) is a resin that can be trickled onto the commutator (1).

10. A power tool, characterized in that the power tool has an electric motor comprising a commutator (1) according to claim 1.

11. A method for the production of a commutator (1) with electrically conductive commutator segments (12), which are disposed about an axis of rotation (10) without a compression-molded body and which are electrically insulated from each other by means of an air gap (14) disposed between two adjacent commutator segments (12), characterized in that a fixing agent (42) is applied to the commutator (1) in the free-flowing phase without a mold and is cured after a flow process between two commutator segments (12) adjoining in the circumferential direction about the axis of rotation (10), and that the position of the commutator segments (12) is fixed by the cured fixing agent (42).

12. The method according to claim 11, characterized in that the fixing agent is not applied until the electrical connecting leads for the windings of a motor or a generator have been already connected to the commutator segments.
